(19) United States
(12) Patent Application Publication
(10) Pub. No.: US 2025/0284275 A1
(43) Pub. Date: Sep. 11, 2025

(54) COMPUTATIONAL MODELING FOR PREDICTIVE COMPONENT INTEGRATION

(71) Applicant: INTERNATIONAL BUSINESS MACHINES CORPORATION, Armonk, NY (US)

(72) Inventors: Brandon Purcell, San Jose, CA (US); Ho-Yiu Lam, Mountain View, CA (US); Steven Hurley, Denton, TX (US)

(21) Appl. No.: 18/601,444

(22) Filed: Mar. 11, 2024

(51) Int. Cl. G05B 23/02; G06F 30/20

(52) U.S. Cl. CPC G05B 23/0283; G05B 23/0254; G06F 30/20

(57) ABSTRACT

Techniques are disclosed to assemble manufactured products using live data about components for a production process. A tolerance analysis model is used to simulate tolerances at each operation of the production process. Live data is fed into the tolerance analysis model, and the tolerance analysis model provides an assembly prediction of failure. Products are assembled according to the assembly prediction of failure. The assembled products are compared with the assembly prediction. The tolerance analysis model is retrained with deviations determined from the comparing of the assembly prediction with the assembled product to provide a rework prediction. The assembled products can be reworked using the rework prediction.

### BACKGROUND

The present invention generally relates to manufacturing, and more particularly to automated assembly of high tolerance components.

Stack up tolerance failures can occur in various industries, including automotive, aerospace, electronics, and consumer goods. They can arise in assemblies that involve mating parts, such as gears, bearings, shafts, or in assemblies with multiple mechanical or electrical components that need to fit together precisely. Tolerance stack up failure is a phenomenon that occurs when the cumulative effect of individual component tolerances leads to functional or dimensional issues in an assembly.

Aesthetic issue, functional failure, structural integrity, safety concern. Increase process churn., etc. in both prime production and warranty repair.

### SUMMARY

In accordance with an embodiment of the present invention, a computer implemented method is provided to process real-time production data to calculate and simulate tolerance stacking at each operation of a production process. In an embodiment, the computer implemented method can include receiving live data about components for a production process resulting in an assembled product. A tolerance analysis model is generated to simulate tolerances at each operation of the production process. The live data is fed into the tolerance analysis model. The tolerance analysis model provides an assembly prediction for failure for the components of the assembled product. The assembled product is built according to the assembly prediction. The assembled product is compared to the assembly prediction, wherein deviation from the assembly prediction in the assembled product is used to retrain the tolerance analysis model. The retrained tolerance analysis model can provide a rework prediction to rework the assembly without assembly tolerance faults.

In another embodiment, a system is provided for assembling products using manufacturing processes. The system can include a hardware processor, and a memory that stores a computer program product. The computer program product, when executed by the hardware processor, causes the hardware processor to receive live data about components for a production process resulting in an assembled product. The computer program product of the system can also generate a tolerance analysis model to simulate tolerances at each operation of the production process. The computer program product can then feed the live data into the tolerance analysis model. The tolerance analysis model provides an assembly prediction of failure for the components of the assembled product. The computer program product of the system can then provide instructions to build the assembled product according to the assembly prediction. The computer program product can then compare the assembled product to the assembly prediction. The computer program product of the system can then employ any deviation from the prediction in the assembled product to retrain the tolerance analysis model. The retrained tolerance analysis model provides a rework prediction to rework the assembly without assembly tolerance faults.

In yet another embodiment, a computer program product is provided for assembling products using manufacturing processes. In an embodiment, the system can include a hardware processor; and a memory that stores a computer program product. The computer program product, when executed by the hardware processor, causes the hardware processor to receive live data about components for a production process resulting in an assembled product. The computer program product can also generate a tolerance analysis model to simulate tolerances at each operation of the production process. The computer program product can then feed the live data into the tolerance analysis model. The tolerance analysis model provides an assembly prediction of failure for the components of the assembled product. The computer program product can then provide instructions to build the assembled product according to the assembly prediction. The computer program product can then compare the assembled product to the assembly prediction. The computer program product can then employ any deviation from the prediction in the assembled product from the assembly prediction to retrain the tolerance analysis model. The retrained tolerance analysis model provides a rework prediction to rework the assembly without assembly tolerance faults.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram of a showing a computer implemented method to prevent integration failures in assembly manufacturing, in accordance with an embodiment of the present invention;

FIG. 2 is an illustration of an example environment illustrating a neural network for an artificial intelligence model, in accordance with an embodiment of the present invention;

FIG. 3 is a block diagram illustrating one embodiment of a system for prevent integration failures in assembly manufacturing, in accordance with an embodiment of the present invention; and

FIG. 4 is a block diagram illustrating a processing system that can incorporate the system for providing a requirement depicted in FIG. 3, in accordance with an embodiment of the present invention.

### DETAILED DESCRIPTION

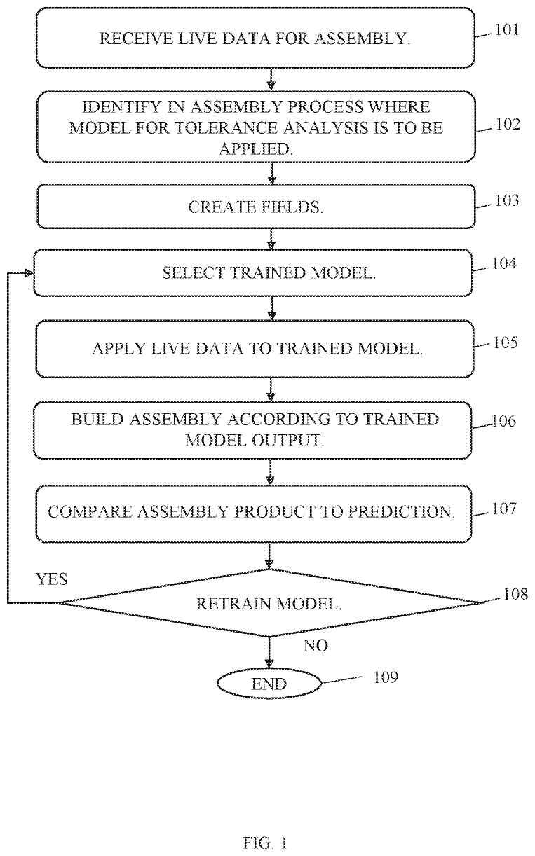

In some embodiments, the computer implemented methods, systems and computer products described herein process real time, production data to calculate and simulate the tolerance stacking at each step to direct part flow and maximize throughput. The computer implemented methods, systems and computer program products can also utilize real time data to identify an ideal sub-component for “on demand” rework of assembled products that have been deemed to fail during tolerance analysis for tolerance stacking. Reworking may be performed to optimize yield. The computer implemented methods, systems and computer program products can also produce a historical record to assist in more accurate inventory forecasts for reworking components. In some embodiments, the computer implemented methods, systems and computer program products can be useful for applications to automotive and medical device structure assembly. The methods, systems and computer program products of the present disclosure are now discussed in greater detail with reference to FIGS. 1-4.

FIG. 1 is a block/flow diagram of a showing a computer implemented method to prevent integration failures in assembly manufacturing. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In some embodiments, the computer implemented method can predict tolerance stacking related failures in assembly manufacturing. The relationship between 3D design and mechanical tolerances opens the potential for real-time predictive data analysis of component integration limiting yield loss, churn, and process simplification. The system has the ability to recommend ideal sub-components for a desirable manufacturing final assembly. The computer implanted method analyzes risk of a given process in real time.

In some embodiments, the computer implemented method for assembly can include receiving live data about components for a production process resulting in an assembled product, and generating a tolerance analysis model to simulate tolerances at each operation of the production process. The method may also include feeding the live data into the tolerance analysis model, wherein the tolerance analysis model provides an assembly prediction of failure, and building the assembled product according to the assembly prediction. The method also can include comparing the assembled product to the assembly prediction, and retraining the tolerance analysis model with deviations determined from the comparing of the assembly prediction with the assembled product to provide a rework prediction. Finally, the method can include reworking the assembled product using the rework prediction. The tolerance analysis model also includes a Monte Carlo simulation analysis for stacking defects. The rework prediction can include instructions to rework the assembled product without assembly tolerance faults.

In an embodiment, the method may begin at block 101. Block 101 includes receiving a live data flow. In some embodiments, the data at this stage of the process flow can include geometric shape data, e.g., three dimensional geometric shape data. Additionally, the data may include a description of how geometric shapes are configured to fit together, which may be referred to as mechanical positioning. This information is used for tolerance analysis. Further, tooling and measurement systems tolerances are also included in the data flow. Even further, the live data flow may include inventory information. For example, the component being assembled can be a compilation of parts. Additionally, a plurality of those subcomponents within those parts may be interchangeable. By providing a live inventory, it can be determined what parts are needed, and what parts are available for assembly including alternative parts.

The aforementioned live data is recorded as assembly procedures are conducted. As will be discussed herein, engineering data and inventory data can be used to continually train and retrain a model for tolerance analysis. The retraining of the model can be done using quantum computing. The live data may be recorded data that is entered into the live data stream by the user, or the live data could be measured from sensors in the manufacturing line for the assembled product, or the live data could be measured from quality testing for the assembled product. Any means for recording and delivering the data may be employed in the present invention.

It is noted that the aforementioned examples are provided for illustrative purposes only. Any information used in tolerance analysis may be collected at this stage of the computer implemented method. For example, any information that can be collected for the purposes of avoiding stacking defaults in manufacturing assembly can with within the scope of the process step for block 101.

For example, in an embodiment, the method to prevent integration failures in assembly manufacturing can be applied to automotive applications, such as the assembly of a door panel to a vehicle body. In this example, the data can include the geometric shape of the door, the geometric shape of the door opening on the vehicle body, as well as the tolerances for assembly robots for securing the door to the vehicle body using fasteners.

For example, in an embodiment, the method to prevent integration failures in assembly manufacturing can receive a live data flow for any information needed for the assembly of magnetic tape drives. For example, a tape drive may have a plurality of components that when assembled can have a performance that can be measured, e.g., electrically, such as the resistance of an assembly of electrical components.

It is noted that the automotive door assembly and magnetic tape drive examples are only two examples that the computer implemented methods are applicable to, and it is not intended that the present disclosure be limited to only this example.

The live data flow may be provided from component suppliers and/or from a record for an internal manufacturing process. In the example for the application of the computer implemented method for assembly manufacturing of automotive structures, the source of the live data flow may be any party within an automotive supply chain. The automotive supply chain can be segmented into OEM manufacturers, Tier 1, Tier 2 and Tier 3 suppliers. Tier 3 form the foundation, supplying raw materials, such as metals and plastic, needed by Tier 2 and Tier 1 suppliers. Tier 2 suppliers buy raw materials from Tier 3 and use them to produce parts needed by Tier 1. OEM manufactures assemble tier 1 products in final assembly of a product.

The computer implemented method may continue to block 102. Block 102 includes identifying where a model for tolerance analysis should be applied in the process for assembling a manufacturing product. The tolerance analysis can be for tolerance in stacking defects. In some embodiments, block 102 can include identifying manufacturing processes are used in assembly, and how the identified manufacturing processes using the data from block 101 can result in manufacturing assembly defects, such as stacking defects. By determining the steps and/or equipment of a manufacturing process that can result in an assembly defect, the point in the manufacturing process can be identified where a model can be applied for the purposes of reducing assembly defects, such as stacking faults.

Block 103 includes creating fields for the application of the model for tolerance analysis. The fields include the appropriate data for the point in the process for assembling the manufactured product to which the model for tolerance analysis is applied for avoiding assembly defects. Creating fields can include cleaning and transforming data for use in the model for applied for reducing assembly defects. Data cleaning is the process of fixing or removing incorrect, corrupted, incorrectly formatted, duplicate, or incomplete data within a dataset. For example, the data received at block 1 may include dimensions that are not relevant to the manufacturing step at which the model is going to be applied, or the data may include duplicate dimension or types of dimensions that can be considered to be functionally equivalent. When combining multiple data sources, there are many opportunities for data to be duplicated or mislabeled. The cleaning step removes these types of data points. For example, in the application of automotive assembly, a doors interior dimensions may be cleaned from data used in a process that is installing a door to a vehicle body, which requires a knowledge of exterior dimensions.

In some embodiments, data transformation process involves defining the structure, mapping the data, extracting the data from the source system, performing the transformations, and then storing the transformed data in the appropriate dataset. Data then becomes accessible, secure and more usable, allowing for use in a multitude of ways. The transformation process may link the dimensional data for the geometry of a part to the process for assembly that is identified in block 102.

It is noted that the data transformation process at block 103 can begin with the dimensional attributes of each sub-component for assembly, and convert that data so that it may be used in a model to illustrate correct assembly of the sub-components in a single assembly. Because the data can come from multiple sources, data transformation process can format the data so that each piece of data can be used in the same model.

Referring to FIG. 1, the computer implemented method may continue with block 104. Block 104 includes selecting and training a model for model for tolerance analysis. Models for tolerance analysis can include Monte Carlo simulation, worst case or arithmetic tolerancing, simple statistical tolerancing or the Root Sum of the Squares (RSS) method. Each of the aforementioned models may be applied to a stack up calculation for determining whether a stack up fault may occur.

For example, Monte Carlo simulation can provide a technique to estimate the probability of an uncertain event taking place. Mechanism situations well suited to Monte Carlo simulation include complex shapes involving non-linear surfaces, like some types of cams, or non-linear forces, like some types of springs. Monte Carlo simulation can also be suitable for components with non-normal distributions, also known as non-Gaussian, of their dimensional variations. For instance, a part's variations might not be distributed as a normalized bell curve around a mean value—it might be skewed in a Weibull distribution. Examples of statistical distributions suitable for use in a Monte Carlo simulation with a tolerance analysis software tool can include Gaussian distribution, uniform, triangular, Weibull, 2D Gaussian (for concentric circles and position constraints only), 2D Circular Uniform (for concentric circles and position constraints only), 2D Circular Gaussian (for concentric circles and position constraints only), 2D Pin in Hole (for pin-in-hole constraints only), truncated Gaussian, trapezoidal and combinations thereof.

Monte Carlo simulation uses random numbers based on a statistical distribution to represent the geometric and dimensional variation of individual components. A number of trials are run with each trial assigning a variation in one or more components, while keeping other variables constant. The combined results of these trials provide a probability estimate that the assembly will fail to meet requirements.

For example, worst-case tolerance analysis is an example of a tolerance Stack up calculation. The individual variables are placed at their limits to make the stack up distance as large or as small as possible. In the worst-case method, the distribution of the individual variables is not considered. Instead, it is assumed that all parts are produced at their extreme limit of acceptability and assembled together in the same assembly unit. This method can help to predict the absolute upper and lower limits of the stack up distance that can be achieved with all acceptable parts. Designing to meet the worst-case tolerance requirements requires that all parts produced to their extreme limits assemble and function.

Assigning a tolerance that meets the worst-case analyses method is often required for critical mechanical interfaces and spare-part replacement interfaces. The worst-case model often requires close-fitting individual component tolerances resulting in expensive manufacturing and inspection processes and higher scrap rates.

The statistical analysis method can take advantage of the principles of statistics to relax the component tolerances without sacrificing quality. Each contributing dimension is assumed to have a statistical distribution. These distributions are combined to predict the distribution of the assembly stack up distance. Statistical analysis therefore predicts a distribution of the stack up distance instead of the possible extreme limits that the worst-case method determines. This analysis model can provide increased design flexibility to design to any quality level, not just 100 percent. Nor does this analysis model assume that the assembly quality level must be the same as the part quality level-a fundamental assumption of the RSS method described below.

The standard deviation calculated for the normal distribution of each dimension is calculated from the following formula for Cp:

$${C}_{p} = \frac{U T L - L T L}{6 σ}$$

where
   UTL=Upper Tolerance Limit
   LTL=Lower Tolerance Limit
   σ=distribution standard deviation

Solving for the standard deviation yields:

$$σ = \frac{U T L - L T L}{6 {C}_{p}}$$

The most common assumption of Cp=1.0 stems from the assumption that manufacturing will select a manufacturing process that will place the defined tolerances at +/− 3 standard deviations from center of the tolerance zone, assumed to be the mean, so that the probability of a part complying to the required tolerances is 99.7%. For all statistical analyses Creo EZ Tolerance Analysis assumes that manufacturing will target the midpoint of the tolerance range, and the mean is assumed to be the midpoint of the tolerance range.

Root Sum of the Squares, or RSS, analysis leverages the principals of the general statistical analysis method described above but with some simplifying assumptions for calculations with tolerances instead of standard deviations. One of the primary assumptions is that the ratios of each of the tolerances to their associated standard deviations on the dimensions and the stack up result, are the same. For an RSS analysis Creo EZ Tolerance Analysis assumes a Cp of 1.0 for all dimensions and the resulting stack up limits.

It is noted that the above four models are only some examples of models that can be applied to creating a model that can be used for creating a model for the tolerance analysis. Additionally, the model must be trained. Training includes using historical values for the live data to train the mode at block 104. For example, the model may be used with a machine learning and/or artificial intelligence application. For example, the model by be used in combination with a neural network. The historical data may be used in training the model using the neural network. The historical data is similar in type to the live feed data that is described above with reference to block 101. For example, similar to the live feed data, the historical data may include supplier build data. For example, the historical data can include geometric shape data, e.g., three dimensional geometric shape data. Additionally, the historical data may include a description of how geometric shapes are configured to fit together, which may be referred to as mechanical positioning. Further, tooling and measurement systems tolerances are also included with the historical data. Even further, the historical data may include inventory information. The historical data can include mechanical positioning of tooling and components for assembly. The historical data can also include tooling dispositions, electrical information, as well as parametric findings. In yet other examples, the historical information can be used that includes a historical build integration of a components, as well as “pass”/“fail” categories.

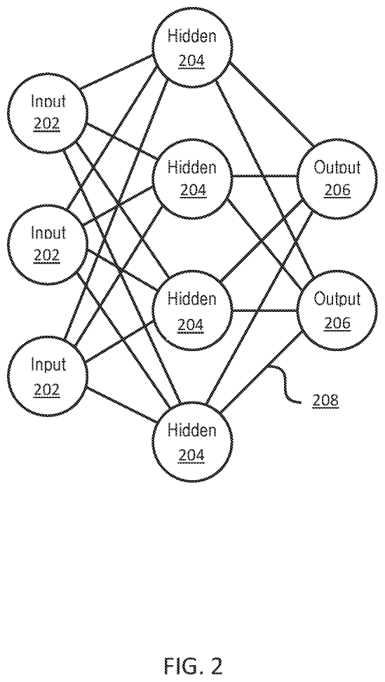

Using the historical data, the model is trained with a neural network. FIG. 2 is an illustration of an example environment illustrating a neural network for an artificial intelligence model. It is noted that neural networks and feed forward computations are further explained with reference to FIG. 2. An artificial neural network (ANN) is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 2, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 202 that provide information to one or more “hidden” neurons 204. Connections 208 between the input neurons 202 and hidden neurons 204 are weighted, and these weighted inputs are then processed by the hidden neurons 204 according to some function in the hidden neurons 204. There can be any number of layers of hidden neurons 204, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 206 accepts and processes weighted input from the last set of hidden neurons 204.

This represents a “feed-forward” computation, where information propagates from input neurons 202 to the output neurons 206. Upon completion of a feed-forward computation, the output is compared to a desired output available from training data. The error relative to the training data is then processed in “backpropagation” computation, where the hidden neurons 204 and input neurons 202 receive information regarding the error propagating backward from the output neurons 206. Once the backward error propagation has been completed, weight updates are performed, with the connections 208 having their weight being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. For example, the aforementioned historical data may provide the training set. Performance data, e.g., a percentage of successfully assembled products, from the historical data can provide the testing set. During training, the inputs of the training set are fed into the ANN employing one of the aforementioned models, e.g., a Monte Carlo simulation assembly model, using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each of the connections 208 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the connections 208 have weights that may be implemented as resistive processing units (RPUs), generating a predictable current output when an input voltage is applied in accordance with a settable resistance.

In some examples, data is fed into an appropriate tolerance model with live data feed and historical mechanical information. Prediction modeling is used for machine functionality/intended use and/or critical metrics in a process that provides the most benefit. As illustrated above, quantum computing, e.g., a neural network, may be used to test assembly integration based on tolerance stacking for key metrics that will output a decision of a given process.

Referring back to FIG. 1, the method can continue to block 105. Using the trained model from block 104, the live data from block 101 that has been processed according to blocks 102 and 103 may be fed into the trained model at block 105. Using the trained model, the live data can provide an assembly prediction, e.g., by prediction modeling, to test assembly integration. For example, the assembly prediction can include what components may be assembled, the assembly methods, and the testing parameters by which the assembled component can be tested, e.g., tested for stacking faults. More particularly, a recommended components combination can be provided. Block 105 can provide a probabilistic result. For example, the results can track and identify high failure components, and assign a probability of failure, e.g., failure probabalistic. The result, e.g., output, from the model can be a numerical outcome desirable to manufacturing to aid in final assembly. For example, the result can be a combination of components assembled using a manufacturing method that includes a testing method that provides when the assembly meets the testing methods that the assembly will likely be free of assembly faults, such as stacking faults.

Block 106 includes building an assembly according to the assembly prediction from block 105. The assembly is built according to the assembly prediction, in which the assembly prediction includes an assembly of specified components, manufacturing processes for assembling the components, and test procedures for testing the assembled components.

In an embodiment, block 107 includes to compare the assembled product to the assembly prediction. For example, the assembly prediction may indicate an assembly of three components and an electrical performance being measured for the three assembled components intended to illustrate an assembly that has been correctly manufactured. If the assembly that was built following the assembly prediction has a measured testing performance that matches the predicted testing performance from the model, the model may be sufficient for further use without additional revision. However, if the assembly that was built has a measured testing performance that does not match the predicted testing performance from the assembly prediction, than the assembly could have a stacking error.

At block 108, a decision is made as whether to retrain the tolerance model. For example, when the assembly that was built following the assembly prediction at block 107 has a measured testing performance that matches the predicted testing performance from the model, no further retraining of the model is needed and assemblies are being produced meeting assembly tolerances, e.g., there are no stacking faults. This can end the assembly process at block 109.

However, at block 108, the decision may be that the previous assembly did not meet performance requirements of the assembly prediction, and a stacking fault can be present. A deviation between the performance of the actually built assembly and the predicted performance of the prediction assembly could be used to retrain the tolerance model. Retraining of the tolerance model may include the process looping back to block 104. In some examples, this could include identifying failure and ranking the subcomponents in the assembly, and using that data to retrain the tolerance model. In view of the historical data, this data can help to trace and identify high failure components. This can also include considering data regarding available inventory. This step can be referred to retraining the model for a rework step.

Referring to FIG. 1, in some embodiments, with a retrained tolerance model, the live data can again be applied to the retrained tolerance model at block 105, and a rework recommendation can then be made for replacement of a subcomponent in the assembly at block 106. Further, an assembly can be built using the rework prediction produced by the retrained tolerance model at block 107, which can provide for replacement of a subcomponent in the assembly that caused prior stacking faults. The revised assembly (also referred to as reworked assembly) can then be tested and compared with the prediction for the retrained tolerance model to determine whether retraining of the tolerance model can be needed at block 108. Reworking can include substituting one component in the assembly having a stacking fault with a replacement component from the existing inventory that is marked to be an equivalent structure.

Exemplary applications/uses to which the present invention can be applied include, but are not limited to manufacturing of assembled products, such as automotive structures and electrical components. The electrical components can be memory tape drives, and/or computing devices, such as tablet computers, smart phones, etc.

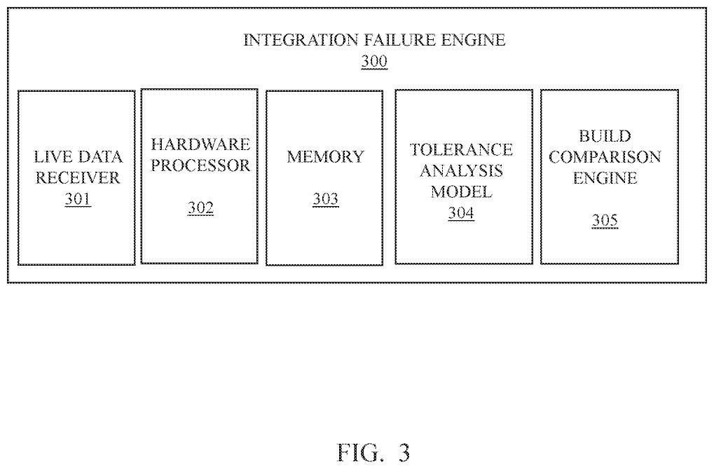

FIG. 3 is a block diagram of a system 300 (integration failure engine) for preventing integration failures in assembly manufacturing. The system can include a hardware processor 302; and a memory 303 that stores a computer program product. The computer program product of the system 300 (integration failure engine) includes instructions that can include to receive, using the hardware processor 302, live data about components for a production process resulting in an assembled product. The instructions can further include to generate, using the hardware processor 302, a tolerance analysis model to simulate tolerances at each operation of the production process. The instructions may also include to feed, using the hardware processor 302, the live data into the tolerance analysis model, wherein the tolerance analysis model provides an assembly prediction of failure. The instructions can further provide that the system build, using the hardware processor 302, the assembled product according to the assembly prediction of failure. The system can also compare, using the hardware processor 302, the assembled product to the assembly prediction. They system may also retrain, using the hardware processor 302, the tolerance analysis model with deviations determined from the comparing of the assembly prediction with the assembled product to provide a rework prediction. In some examples, the system 300 (integration failure engine) can rework, using the hardware processor, the assembled product using the rework prediction.

Referring to FIG. 3, the live data receiver 301 of the system 300 (integration failure engine) can collect live data, as described with respect to block 101 of the methods described above with reference to FIG. 1. The live data receiver 301 can further provide the functions of formatting the data that is described in blocks 102 and 103 of FIG. 1.

Still referring to FIG. 3, the system 300 (integration failure engine) also includes a tolerance analysis model 304. Further details for the tolerance analysis model 304, and its functions is found in the description of blocks 104, 105 and 108 of FIG. 1.

Referring to FIG. 3 the system 300 (integration failure engine) can also include a build comparison engine 305. The build comparison engine can compare an assembled product to the assembly prediction provided by the tolerance analysis model. Further details for the tolerance analysis model 304 is found in the description of blocks 106 and 107 of FIG. 1.

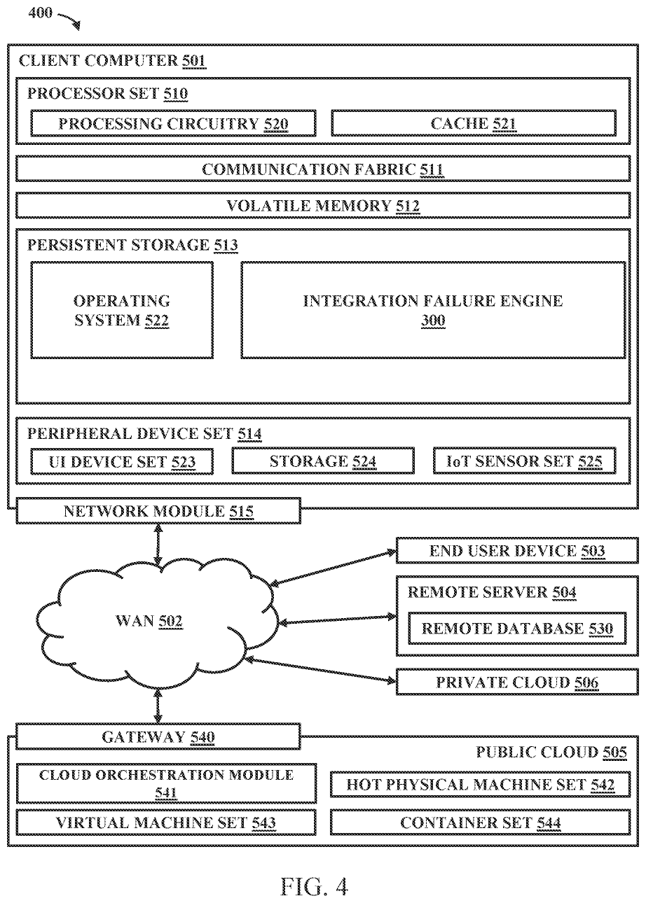

Referring to FIG. 4, in some embodiments, the components of the system 300 (integration failure engine) are in communication with at least one processor (processor set 510), in which the hardware processor may function with the other elements depicted in FIG. 10 to provide the functions described above. FIG. 10 further illustrates a computing environment 400 that can include the system 300 (integration failure engine) that is described with reference to FIGS. 1-4.

Referring to FIG. 4, the computing environment 400 contains an example of an environment for the execution of at least some of the computer code involved in performing the inventive methods, such as the method to prevent integration failures in assembly manufacturing. In addition to the system 300 (integration failure engine), the computing environment 400 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and the system 300 (integration failure engine), as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

The computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, e.g., computer 501, to keep the presentation as simple as possible.

Computer 501 may be located in a cloud, even though it is not shown in a cloud in FIG. 4. On the other hand, computer 501 is not required to be in a cloud except to any extent as may be affirmatively indicated.

The processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is used for data or code that should be available for rapid access by the threads or cores running on processor set 510. Cache memories are organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 400, at least some of the instructions for performing the inventive methods may be stored in system 300 (integration failure engine) in persistent storage 513.

The communication fabric 511 is the signal conduction paths that allow the various components of computer 501 to communicate with each other. This fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 512 is any type of volatile memory now known or to be developed in the future. Examples include dynamic type random access memory (RAM) or static type RAM. The volatile memory can be characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

The persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in the system 300 (integration failure engine) may include at least some of the computer code involved in performing the inventive methods.

The peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

The network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs include computer hardware such as copper transmission cables, optical transmission fibers, wireless transmission, routers, firewalls, switches, gateway computers and edge servers.

The end user device (EUD) 503 is any computer system that is used and controlled by an end user (for example, a customer of an enterprise that operates computer 501), and may take any of the forms discussed above in connection with computer 501. The end user device (EUD) 503 receives helpful and useful data from the operations of computer 501. For example, in a hypothetical case where computer 501 is designed to provide a recommendation to an end user, this recommendation would be communicated from network module 515 of computer 501 through WAN 502 to the end user device (EUD) 503. In this way, the end user device (EUD) 503 can display, or otherwise present, the recommendation to an end user. In some embodiments.

The end user device (EUD) 503 may be a client device, such as thin client, heavy client, mainframe computer, desktop computer and so on.

The remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

The public cloud 505 is any computer system available for use by multiple entities that provides on-demand availability of computer system resources and/or other computer capabilities, especially data storage (cloud storage) and computing power, without direct active management by the user. Cloud computing leverages sharing of resources to achieve coherence and economies of scale. The direct and active management of the computing resources of public cloud 505 is performed by the computer hardware and/or software of cloud orchestration module 541. The computing resources provided by public cloud 505 are implemented by virtual computing environments that run on various computers making up the computers of host physical machine set 542, which is the universe of physical computers in and/or available to public cloud 505. The virtual computing environments (VCEs) take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The present invention may be a system, a method, and/or a computer program product at any possible technical detail level of integration. For example, in some embodiments, a computer program product is provided for layer normalization in machine learning applications. The computer program product can include a computer readable storage medium having computer readable program code embodied therewith. The program instructions executable by a processor to cause the processor to receive live data about components for a production process resulting in an assembled product, and generate a tolerance analysis model to simulate tolerances at each operation of the production process. The computer program product using the processor can also feed the live data into the tolerance analysis model, wherein the tolerance analysis model provides an assembly prediction of failure, and build the assembled product according to the assembly prediction of failure. The compute program product and also compare the assembled product to the assembly prediction, and retrain the tolerance analysis model with deviations determined from the comparing of the assembly prediction with the assembled product to provide a rework prediction. The computer program product can also rework the assembled product using the rework prediction. The rework prediction includes instructions to rework the assembled product without assembly tolerance faults.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is moved at some occasional points in time during normal operations of a storage device, such as during access, de-fragmentation or garbage collection, but this does not render the storage device as transitory because the data is not transitory while it is stored.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for systems and methods to prevent integration failures in assembly manufacturing (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer implemented method for assembly comprising:
receiving live data about components for a production process to result in an assembled product;
generating a tolerance analysis model to simulate tolerances at each operation of the production process;
feeding the live data into the tolerance analysis model, wherein the tolerance analysis model provides an assembly prediction of failure;
building the assembled product according to the assembly prediction of failure;
comparing the assembled product to the assembly prediction;
retraining the tolerance analysis model with deviations determined from the comparing of the assembly prediction with the assembled product to provide a rework prediction; and
reworking the assembled product using the rework prediction.

2. The computer implemented method of claim 1, wherein the tolerance analysis model includes a Monte Carlo simulation for stacking defects.

3. The computer implemented method of claim 1, wherein the live data is real time data from an assembly process, the live data including sub assembly component dimensions, assembly data and component inventory.

4. The computer implemented method of claim 1, wherein the tolerance analysis model is a provided by a neural network performing a Monte Carlo simulation using historical data on the production process.

5. The computer implemented method of claim 1, wherein the assembly prediction includes a list of components to be assembled into the assembled product, process steps for assembling the components, and testing characteristics indicative of correct assembly.

6. The computer implemented method of claim 1, wherein the rework prediction includes instructions to rework the assembled product without assembly tolerance faults.

7. The computer implemented method of claim 1, wherein the assembled products is a tape drive.

8. A system for assembling products including a hardware processor; and a memory that stores a computer program product, the computer program product of the system includes instructions comprising:
receive, using the hardware processor, live data about components for a production process resulting in an assembled product;
generate, using the hardware processor, a tolerance analysis model to simulate tolerances at each operation of the production process;
feed, using the hardware processor, the live data into the tolerance analysis model, wherein the tolerance analysis model provides an assembly prediction of failure;
build, using the hardware processor, the assembled product according to the assembly prediction of failure;
compare, using the hardware processor, the assembled product to the assembly prediction; retrain, using the hardware processor, the tolerance analysis model with deviations determined from the comparing of the assembly prediction with the assembled product to provide a rework prediction; and
rework, using the hardware processor, the assembled product using the rework prediction.

9. The system of claim 8, wherein the tolerance analysis model includes a Monte Carlo simulation for stacking defects.

10. The system of claim 8, wherein the live data is real time data from an assembly process, the live data including sub assembly component dimensions, assembly data and component inventory.

11. The system of claim 8, wherein the tolerance analysis model is a provided by a neural network performing a Monte Carlo simulation using historical data on the production process.

12. The system of claim 8, wherein the assembly prediction includes a list of subcomponents to be assembled into the assembled product, process steps for assembling the subcomponents, and testing characteristics indicative of correct assembly.

13. The system of claim 8, wherein the rework prediction includes instructions to rework the assembled product without assembly tolerance faults.

14. The system of claim 8, wherein the assembled product is a tape drive.

15. A computer program product for layer normalization in machine learning applications, the computer program product including a computer readable storage medium having computer readable program code embodied therewith, program instructions executable by a processor to cause the processor to:
receive live data about components for a production process resulting in an assembled product;
generate a tolerance analysis model to simulate tolerances at each operation of the production process;
feed the live data into the tolerance analysis model, wherein the tolerance analysis model provides an assembly prediction of failure;
build the assembled product according to the assembly prediction of failure;
compare the assembled product to the assembly prediction;
retrain the tolerance analysis model with deviations determined from the comparing of the assembly prediction with the assembled product to provide a rework prediction; and
rework the assembled product using the rework prediction.

16. The computer program product of claim 15, wherein the tolerance analysis model includes a Monte Carlo simulation for stacking defects.

17. The computer program product of claim 15, wherein the live data is real time data from an assembly process, the live data including sub assembly component dimensions, assembly data and component inventory.

18. The computer program product of claim 15, wherein the tolerance analysis model is a provided by a neural network performing a Monte Carlo simulation using historical data on the production process.

19. The computer program product of claim 15, wherein the assembly prediction includes a list of subcomponents to be assembled into the assembled product, process steps for assembling the subcomponents, and testing characteristics indicative of correct assembly.

20. The computer program product of claim 15, wherein the rework prediction includes instructions to rework the assembled product without assembly tolerance faults.
